(19) United States
(12) Patent Application Publication
(10) Pub. No.: US 2003/0230632 A1
(43) Pub. Date: Dec. 18, 2003

(54) Control system for room air conditioning

(76) Inventor: Henry S. Morris, Paradise Valley, AZ (US)

Correspondence Address: WILLIAM C. CAHILL, 155 PARK ONE, 2141 E. HIGHLAND AVENUE, PHOENIX, AZ, 85016, US

(21) Appl. No.: 10/170,766

(22) Filed: Jun. 13, 2002

(51) Int. Cl. G05D 23/00; F25B 19/00

(52) U.S. Cl. 236/47; 236/51

(57) ABSTRACT

A room air conditioning control system incorporates a motion detector strategically placed in the room to detect the presence of activity in the room and enable a room air conditioning unit to operate and thus adjust the room temperature to a pre-selected level. The motion detector, upon detection of motion within the room, switches a transmitter to transmit an RF signal to a receiver connected in the power line of the room air conditioning unit. The receiver connects power to the unit and maintains such power for a predetermined time after motion within the room is no longer detected. The motion detector and transmitter operate on battery power, and the control system operates without hard wiring to permit the system to be added to an existing room air conditioning system.

### FIELD OF THE INVENTION

The present invention relates to the control of air conditioning systems, and more particularly to such systems for heating and/or cooling a room in response to activity within the room.

### BACKGROUND OF THE INVENTION

The requirement for efficiency in a heating and/or cooling of a room is particularly acute in applications such as hotels and motels. In the rooms available for occupancy in such structures, it is common for the temporary occupant to be able to set or control the temperature of the room to meet the individual's comfort needs. When the room is unoccupied, it is usually the responsibility of the room clerk or maid service to insure that the thermostat controlling the temperature of the room is reset to a more economical level during the unoccupancy of the room. Further, when the temporary occupant of the room leaves the premises, but does not check out of the hotel or motel, the room is unoccupied, but the selected temperature is maintained by the air conditioning equipment. During this time, energy is being consumed to maintain the desired temperature level, although the temporary occupant of the room is not present.

Prior art control systems have been developed for detecting such events as motion, door opening and the like together with electronic/electrical systems for controlling the temperature of the room in the absence of events such as occupancy and the like. These prior art systems are frequently complex and therefore very expensive to install, particularly in existing structures. There is a need for a temperature control system accounting for the occupancy/unoccupancy of temporarily occupied rooms wherein the hotel or motel has already been constructed and the air conditioning systems have already been installed. The modifications of these installed systems can be overly expensive and therefore seldom justified.

### OBJECTS OF THE INVENTION

It is therefore an object of the present invention to provide an air conditioning control system for use in an existing hotel or motel room to save energy consumed by the air conditioning equipment.

It is also an object of the present invention to provide an air conditioning control system that may be inexpensively incorporated into existing air conditioning systems provided in individual rooms.

It is still another object of the present invention to provide an improved air conditioning control system that may conveniently be placed in a temporarily occupied room without significant and expensive external wiring to modify the existing system.

These and other objects of the present invention will become apparent to those skilled in the art as the description thereof proceeds.

### SUMMARY OF THE INVENTION

The present invention provides an air conditioning control system specifically intended for implementation in an existing hotel/motel without the extensive and expensive modification of the existing air conditioning systems. The present invention incorporates a strategically placed motion detector that can be conveniently located within the respective room to detect motion, and thus occupancy, of the room. This motion detector can be one of several readily available detectors and can be mounted without external wiring and therefore without significant additional cost to the owner of the premises. The signal typically developed by the motion detector triggers a transmitter for transmitting RF or infrared signal; the transmitter need not have external wiring and can be operated efficiently on battery power in a manner quite similar to typical garage door opener transmitters.

The room usually incorporates a window-type air conditioning system with controls available to the temporary occupant to permit them to select a desired temperature. The power to this air conditioning unit is frequently simply a conventional plug-in-type electrical cord which, in the present invention is unplugged and is plugged into a combined switch and receiver. This combined switch and receiver is in turn plugged into the outlet that previously received the power cord from the air conditioning unit. Thus, upon detection of motion by the motion detector, and the subsequent transmittal of the RF or infrared signal and receipt of that signal by the receiver, the power switch to the air conditioning unit is closed and the system may operate to raise or lower the temperature in accordance with the selection by the temporary occupant.

### BRIEF DESCRIPTION OF THE DRAWINGS

FIG. 1 is a plan view of a typical hotel/motel room having the air conditioning control system of the present invention installed therein.

FIG. 2 is a diagrammatic view of the elements of the system of the present invention useful for describing the operation of the present invention.

FIG. 3 is a schematic block diagram of the present invention useful for describing its operation.

### DETAILED DESCRIPTION OF THE PREFERRED EMBODIMENT

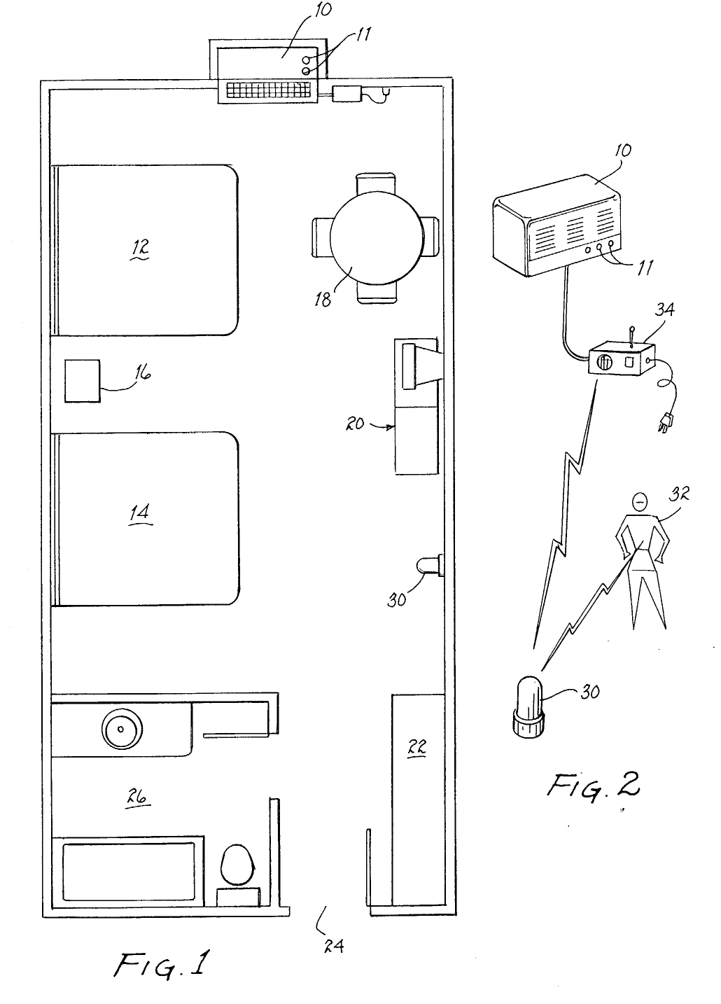

Referring now to FIG. 1 a typical hotel/motel room is shown having a wall or window mounted air conditioning unit 10 installed therein. The air conditioning unit typically will incorporate a plurality of controls 11 to permit the occupant of the room to select a desired temperature as well as a ventilation fan speed, etc. The air conditioning unit is usually connected to 110/220 v electrical power by a power supply line or a simple electrical cord; the connection may be internal without exposed power cables within the room, or it may comprise a typical power plug inserted into a corresponding wall outlet within the room. The latter arrangement is typically found in older motel/hotel units. In the embodiment chosen for illustration, the air conditioning unit 10 is located in an older-type of hotel room construction wherein the air conditioning unit is simply plugged into a conventional wall outlet provided therefor.

The typical room may include one or two beds such as beds 12 and 14 with a night stand 16 separating the two. A table with chairs 18 and a television stand and desk combination 20 may also be provided. Usually a closet 22 is provided near the entry doorway 24; a bathroom 26 is typically positioned as shown. The present invention incorporates a self-powered motion sensor 30 strategically located within the room. The motion sensor 30 is self powered, that is, it contains its own power source such as a battery, and may be any of several commercially available motion detecting systems, most of which incorporate semiconductor sensing elements that are responsive to infrared radiation. The sensitivity of the motion detector can be designed and/or adjusted to provide an indication of motion within the room under conditions of only very slight movement. For example, at night time when the temporary occupant of the room may be in bed, there would normally not be substantial movement in the room; however, the detector can readily detect the normal motion of a sleeping individual simply by detecting typical movements such a turning over in the bed or adjusting one's position in the bed.

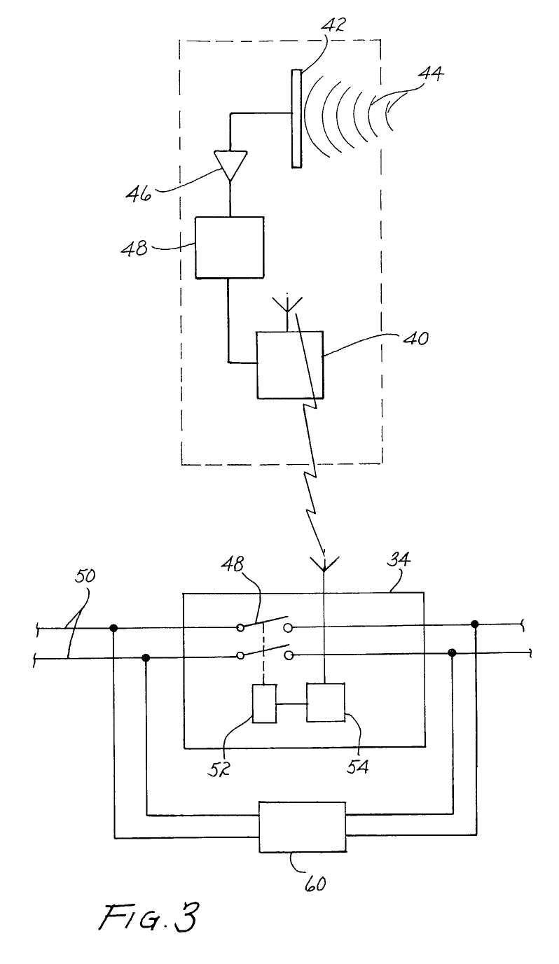

Referring now to FIG. 2, the motion detector 30 is shown schematically detecting the motion of an individual 32 and, as a result of such detection generating a motion signal to trigger the transmission of an RF signal to an RF receiver 34. The transmitter (shown in FIG. 3 at 40) used for transmitting the RF signal is a conventional digital signal transmitter readily available in the art and typically found in such devices as garage door openers, or if the transmitted signal is an infrared signal the transmitter could be a conventional infrared transmitter frequently found in TV remote controllers. The receipt of the RF signal, which may be digitally encoded, by the receiver 34 closes a power switch to permit power to be applied to the air conditioning unit to thereby control the temperature within the room to the setting previously chosen by the occupant.

Referring now to FIG. 3 a schematic block diagram of the system of the present invention is shown. The motion detector of the present invention incorporates the typical semiconductor sensing element 42 that senses changes in infrared energy (schematically shown at 44) impinging on the surface of the semiconductors of the element. A motion signal is thus derived from the sensors and is amplified in a conventional amplifier 46; the amplified signal is applied to a switch 48 that, when operated, applies power to the transmitter 40. The motion sensor 30 includes the transmitter 40 within a single container or package. The entire motion detector/transmitter package is a small unit that can conveniently be located at a strategic location within the room and does not require the addition of wiring to the room. That is, the entire unit is self-powered through the utilization of an easily replaceable battery in a manner well known in the art. The power requirements for the detector and transmitter are very slight and can easily be powered by conventional, readily available lead-acid, Ni-Cad or Lithium batteries that will provide months or years of uninterrupted service. The unit is also provided with a low voltage detection system in a manner similar to that found in remote smoke detector units wherein a low battery voltage results in an audible “chirp” to indicate to the user that the battery needs replacement.

In the embodiment chosen for illustration, the receiver 34 is responsive to the RF signal from the transmitter 40 to close, or to maintain closed, a normally open switch 48 for connecting the power conductors 50 to the air conditioning unit 10 (FIGS. 1 and 2). That is, the air conditioning unit will operate in a normal manner to maintain a predetermined occupant selected temperature so long as the power switch 48 to the unit is closed. The RF signal received by the receiver 34 operates an actuator 52 to maintain the power switch 48 closed; further, the system incorporates a timer 54 that will maintain the switch in its closed position for a predetermined time before permitting the switch to open. In this manner, the air conditioning unit will be maintained in its powered mode even though there is no detection of motion within the room for a predetermined time.

For example, the timer 54 may provide continuous operation of the air conditioning unit to maintain the room temperature at the occupant's selected level for a period of one or two hours after motion is detected within the room. If no further motion is detected after that one or two hour delay (thus indicating the occupant has left the room). The actuator will permit the closed switch 48 to open an thus remove power from the air conditioning unit.

In some instances, it may be desirable to incorporate an auxiliary temperature sensor 60 in the system to maintain the room temperature within a predetermined maximum or minimum temperature even though the room is not occupied. For example, the occupant selected temperature can be maintained within the room during that time that motion is detected therein. After the delay time described above, the air conditioning unit would be disabled and the room temperature would drift toward the outside ambient temperature. It is usually desirable not to permit the ambient temperature within the room to wander beyond a certain predetermined maximum or minimum; this maximum/minimum temperature can be preset in the auxiliary temperature sensor so that the air conditioning unit would be enabled when that maximum/minimum temperature is reached and will operate until that temperature is exceeded. For example, if during the summertime the selected internal temperature is 72° F., the air conditioning unit will maintain that temperature so long as there is a detected motion within the room. If there is no detected motion for a period of time in excess of the predetermined delay time, the switch is opened and power is removed from the air conditioning unit. As the temperature within the room rises toward the ambient outside temperature, and as that temperature reaches a predetermined maximum internal temperature selected by the owner of the premises (typically 80° F. to 85° F.), the auxiliary temperature sensor 60 will switch power to the air conditioning unit to permit the latter to operate for a time sufficient to lower the ambient temperature within the room below this maximum permitted temperature.

It is important to note that the system of the present invention eliminates the necessity of “hard wiring” and therefore substantially reduces the cost of retrofitting each room with the temperature controlling and energy saving features. Prior art systems require hard wiring which may be acceptable for newly constructed hotels/motels but usually presents a prohibitive cost to older units that cannot justify such additional expense. The system of the present invention permits easy installation without hard wiring and therefore results in energy savings to the owner of the premises without the substantial initial investment of hard wiring installations. In addition, the circuits and other elements of the system of the present invention are conventional readily available products that may easily be chosen by those skilled in the art to accommodate specific application requirements. The circuits and elements of the present invention are readily available in the prior art and are well known to those skilled in the art; for example, the RF or infrared transmitter is any well know and conventional transmitter that is designed for use with minimal battery power such as those used in garage door openers or remote controllers. Similarly, the receiver for the RF of infrared transmission can be the same as that used in those same garage door openers or controlled devices such as television sets to receive the signal from a portable transmitter. The switch for opening and closing the power circuit to the air conditioning system is conventional and can be readily designed by those skilled in the art.

The present invention has been described in terms of selected specific embodiments of the apparatus and method incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

I claim:

1. In a room having an air conditioning unit for modifying the temperature in the room, a control system for controlling said unit comprising:
(a) a self-powered motion detector for mounting in said room at a desired strategic location to detect occupancy of the room, said detector generating a motion signal in response to the detection of motion within said room;
(b) a transmitter connected to said motion detector responsive to said motion signal to transmit a signal indicating the detection of motion within said room;
(c) an electrical switch connected to a power source and to said air conditioning unit for connecting and disconnecting said unit to said power source; and
(d) a signal receiver connected to said electrical switch and responsive to the receipt of said signal to operate said switch to close the switch and apply power to said unit.

2. The combination set forth in claim 1 wherein said signal is one of an RF signal and an infrared signal.

3. The combination set forth in claim 1 wherein said switch is normally open.

4. The combination set forth in claim 1 including a timer connected to maintain said switch closed and responsive to the closing of said switch to maintain said switch closed for a predetermined time.

5. For use in a room having an air conditioning unit for modifying the temperature in the room, a control system for controlling said unit comprising:
(a) a battery powered motion detector for mounting in said room at a desired strategic location to detect occupancy of the room, said detector generating a motion signal in response to the detection of motion within said room;
(b) a battery powered transmitter mounted with and connected to said motion detector responsive to said motion signal to transmit a signal indicating the detection of motion within said room;
(c) a normally open electrical switch connected to a power source and to said air conditioning unit for connecting and disconnecting said unit to said power source;
(d) a receiver connected to said electrical switch and responsive to the receipt of said signal to operate said switch to close the switch and apply power to said unit; and
(e) a timer connected to maintain said switch closed and responsive to the closing of said switch to maintain said switch closed for a predetermined time.

6. The combination set forth in claim 5 including an auxiliary temperature sensor responsive to a temperature outside of a predetermined range of temperatures for connecting said power source to said air conditioning unit.
